(19) United States
(12) Patent Application Publication
(10) Pub. No.: US 2013/0160895 A1
(43) Pub. Date: Jun. 27, 2013

(54) SOLDER PASTE FOR PASTING ELECTRONIC PART ON PRINTED CIRCUIT BOARD

(71) Applicants: YAN-ZHENG LIANG, Shenzhen City (CN); QIN XU, Shenzhen City (CN)

(72) Inventors: YAN-ZHENG LIANG, Shenzhen City (CN); QIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/479,304

(22) Filed: May 24, 2012

(30) Foreign Application Priority Data
Dec. 23, 2011 (CN) 201110437689.0

(51) Int. Cl. B23K 35/26

(52) U.S. Cl. 148/24

(57) ABSTRACT

A solder paste includes alloy powder, conductive adhesive, and flux. The mass ratio of the alloy powder to the conductive adhesive is in the range of about 3:1 to 5:1. The mass ratio of the alloy powder to the flux is in the range of about 8:1 to 10:1. The alloy powder includes tin. The weight percentage of the tin in the alloy powder is in the range of about 37.8%˜46.2%.

### BACKGROUND

1. Technical Field

The present disclosure relates to solder pastes, and particularly to solder paste used in the printed circuit board.

2. Description of Related Art

In manufacturing a printed circuit board, solder paste is used for connecting an electronic part to a predetermined pad of the printed circuit board. The intensity of the solder paste is weak, thus the electronic part may be easily apart from the printed circuit board, and further cause the pad connected with the apart electronic part to fall off from the printed circuit board.

Therefore, there is room for improvement in the art.

### DETAILED DESCRIPTION

Solder paste is comprised of alloy powder, conductive adhesive, and flux. The mass ratio of the alloy powder to the conductive adhesive is in the range of about 3:1 to 5:1. The mass ratio of the alloy powder to the flux is in the range of about 8:1 to 10:1.

The particles of alloy powder are substantially spherical. The diameter of the particles of the alloy powder is in the range of about 25 to 45 μm. The major alloy component in the alloy powder is tin, bismuth, and silver. The weight percentage of the tin powder in the alloy powder is in the range of about 37.8%˜46.2%, the weight percentage of the bismuth in the alloy powder is in the range of about 53.36%˜61.84%, and the weight percentage of the silver in the alloy powder is in the range of about 0.36%˜0.44%.

The conductive adhesive can be epoxy resin type conductive adhesive, the conductive adhesive with conductive silica gel, or the conductive adhesive with copper and silver. In the embodiment, the conductive adhesive is a heat curing type conductive adhesive.

The major component of the flux includes colophony, activator, antioxidant, thinner, and so on. In the embodiment, the weight percentage of the colophony in the flux can be more than 80%.

In the manufacturing of the solder paste, the alloy powder, conductive adhesive, and flux are provided as follows: the mass ratio of the alloy powder to the conductive adhesive is in the range of about 3:1 to 5:1, the mass ratio of the alloy powder to the flux is in the range of about 8:1 to 10:1. The weight percentage of the tin powder in the alloy powder is in the range of about 37.8%˜46.2%, the weight percentage of the bismuth in the alloy powder is in the range of about 53.36%˜61.84%, and the weight percentage of the silver in the alloy powder is in the range of about 0.36%˜0.44%. The alloy powder, conductive adhesive, and flux are fully mixed under an airproof condition at a room temperature. Then, the obtained mixture is saved in an airproof container as a solder paste. In the embodiment, the mixed process is completed in about 30 minutes.

The melting point of the solder paste is between about 138° C. and 160° C. The conductive coefficient of the solder paste can be more than 1*10⁻³ ohms When the sealed solder paste is saved in chilling manner with the temperature between about 0° C. and 10° C., the validity period is six months. When the unsealed solder paste is saved in chilling manner with the temperature between about 0° C. and 10° C., the validity period is about two weeks. When the unsealed solder paste is saved under the room temperature, the validity period is about 48 hours. The viscosity of the solder paste is between about 400 Pa*S and 1000 Pa*S. Furthermore, the solder paste is a lead-free and halide-free type solder paste, thus the pollution of the environment is reduced.

The present disclosure is described in detail referring to the following examples.

### EXAMPLE 1

A solder paste was comprised of alloy powder, conductive adhesive, and flux. The mass ratio of the alloy powder to the conductive adhesive was 3:1. The mass ratio of the alloy powder to the flux was 10:1. The weight percentage of the tin powder in the alloy powder was 42%, the weight percentage of the bismuth in the alloy powder was 57.6%, and the weight percentage of the silver in the alloy powder was 0.4%.

### EXAMPLE 2

A solder paste included alloy powder, conductive adhesive, and flux. The mass ratio of the alloy powder to the conductive adhesive was 4:1. The mass ratio of the alloy powder to the flux was 10:1. The weight percentage of the tin powder in the alloy powder was 42%, the weight percentage of the bismuth in the alloy powder was 57.6%, and the weight percentage of the silver in the alloy powder was 0.4%. The conductive adhesive and the flux were the same as the conductive adhesive and the flux in the example 1.

### EXAMPLE 3

A solder paste includes alloy powder, conductive adhesive, and flux. The mass ratio of the alloy powder to the conductive adhesive was 5:1. The mass ratio of the alloy powder to the flux was 10:1. The weight percentage of the tin powder in the alloy powder was 42%, the weight percentage of the bismuth in the alloy powder was 57.6%, and the weight percentage of the silver in the alloy powder was 0.4%. The conductive adhesive and the flux were the same as the conductive adhesive and the flux in the example 1.

### EXAMPLE 4

A solder paste included alloy powder, conductive adhesive, and flux. The mass ratio of the alloy powder to the conductive adhesive was 6:1. The mass ratio of the alloy powder to the flux was 10:1. The weight percentage of the tin powder in the alloy powder was 42%, the weight percentage of the bismuth in the alloy powder was 57.6%, and the weight percentage of the silver in the alloy powder was 0.4%. The conductive adhesive and the flux were the same as the conductive adhesive and the flux in the example 1.

### EXAMPLE 5

A solder paste only included a conductive adhesive which is the same as the conductive adhesive in the example 1.

The impedance and tensile force of the above examples have been tested. Table 1 below records testing results of the impedance and tensile force of the above examples.

TABLE 1
shows testing result of the impedance and tensile force of the examples

| Example | Impedance testing (Ω) | Tensile force testing (GF) |
|---|---|---|
| Example 1 | 0.068 | 1677.6 |
| Example 2 | 0.088 | 1608.0 |
| Example 3 | 0.127 | 1518.6 |
| Example 4 | 0.541 | 674.4 |
| Example 5 | 0.079 | 521.6 |

From the testing results in table 1, the impedance and the tensile force of the solder paste of the example 1, the example 2, and the example 3 are better than that of the example 4. The tensile force of the solder paste of the example 1, the example 2, and the example 3 is obviously better than of the example 5.

As described, by the above solder paste the conductive ability and the viscosity intensity are improved.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A solder paste capable of pasting an electronic part on a printed circuit board, the solder paste comprising:
alloy powder;
conductive adhesive; and
flux;
wherein the mass ratio of the alloy powder to the conductive adhesive is in the range of 3:1 to 5:1; the mass ratio of the alloy powder to the flux is in the range of 8:1 to 10:1; the alloy powder comprises tin, the weight percentage of the tin in the alloy powder is in the range of 37.8%˜46.2%.

2. The solder paste of claim 1, wherein particles of alloy powder are substantially spherical.

3. The solder paste of claim 2, wherein a diameter of the particles of the alloy powder is in the range of 25˜45 μm.

4. The solder paste of claim 1, wherein the alloy powder further comprises bismuth, and the weight percentage of the bismuth in the alloy powder is in the range of 53.36%˜61.84%.

5. The solder paste of claim 1, wherein the alloy powder further comprises silver, and the weight percentage of the silver in the alloy powder is in the range of 0.36%˜0.44%.

6. The solder paste of claim 1, wherein the flux comprises colophony, and the weight percentage of the colophony in the flux is more than 80%.

7. The solder paste of claim 1, wherein the conductive adhesive is a heat curing type conductive adhesive.

8. The solder paste of claim 7, wherein the conductive adhesive is epoxy resin type conductive adhesive.

9. The solder paste of claim 7, wherein the conductive adhesive comprises conductive silica gel.

10. The solder paste of claim 7, wherein the conductive adhesive comprises copper and silver.

11. The solder paste of claim 1, wherein the melting point of the solder paste is between 138° C. and 160° C.

12. The solder paste of claim 1, wherein the conductive coefficient of the solder paste is more than 1*10⁻³ ohms.

13. The solder paste of claim 1, wherein the viscosity of the solder paste is between 400 Pa*S and 1000 Pa*S.
